(19) United States
(12) Patent Application Publication
(10) Pub. No.: US 2026/0330671 A1
(43) Pub. Date: Oct. 22, 2026

(54) OBJECT POSITIONING DEVICE AND METHOD

(71) Applicant: National Chengchi University, Taipei City (TW)

(72) Inventors: Jyi-Shane Liu, Taipei City (TW); Gong-Yi Lee, Taipei City (TW); Wei-Chung Chen, Taipei City (TW)

(73) Assignee: National Chengchi University, Taipei City (TW)

(21) Appl. No.: 19/207,408

(22) Filed: May 14, 2025

(30) Foreign Application Priority Data
Apr. 22, 2025 (TW) 114115074

(51) Int. Cl. G06T 7/70; G06V 20/17

(52) U.S. Cl. CPC G06T 7/70; G06V 20/17; G06T 2207/10016; G06V 2201/07

(57) ABSTRACT

The disclosure uses an object positioning device and method to analyze a pixel value variation and a brightness variation in continuous images, identify the intersection of the two, and determine the frequency of the flashing light source. It can not only eliminate the instability that may be caused by wind causing the object positioning device to shake during photography, but also can eliminate the noise generated when the target object is temporarily obscured by objects such as leaves, and determine the location of the target object. The disclosed object positioning device and method may be used for wilderness search and rescue in adverse weather conditions, as well as for ground-to-air lighting guidance to achieve precise positioning effects.

### CROSS-REFERENCE TO RELATED APPLICATION

This application claims the priority benefit of Taiwan application serial no. 114115074, filed on Apr. 22, 2025. The entirety of the above-mentioned patent application is hereby incorporated by reference herein and made a part of this specification.

### BACKGROUND

### Technical Field

The disclosure relates to a positioning device and method, and particularly relates to an object positioning device and method.

### Description of Related Art

Currently, when unmanned aerial vehicles (UAVs) perform search and rescue detection and visual guidance, they mainly operate through pattern markers, such as the AprilTag way. However, at a certain flight altitude and visual range, extremely large markers are required to provide sufficiently distinct image features for recognition, which is not suitable for emergency situations or challenging circumstances, such as conducting search and rescue missions in adverse weather conditions. Therefore, how to detect targets in a large area, and to screen out the location of the target through preliminary identification methods, or to guide the target in a large area, is an important issue.

### SUMMARY

In view of the foregoing, the disclosure provides a positioning device and method that identifies a continuous signal of the same frequency emitted by a target object in an image, which serves as a basis for large-scale screening of the area where the object is located.

The disclosure provides an object positioning device, including: a camera and a processor. The processor is coupled to the camera, and configured to: obtain a plurality of images through the camera, where the plurality of images are continuous images in time sequence, and the plurality of images include a first object emitting a first frequency light source; analyze a pixel variation in the plurality of images to obtain a plurality of first target areas; analyze a brightness variation in the plurality of images to obtain a plurality of second target areas; and obtain an intersection area of the plurality of first target areas and the plurality of second target areas to obtain an area where the first object is located.

The disclosure also provides an object positioning method, including: obtaining a plurality of images through a camera, where the plurality of images are continuous images in time sequence, and the plurality of images include a first object emitting a first frequency light source; analyzing a pixel variation in the plurality of images to obtain a plurality of first target areas; analyzing a brightness variation in the plurality of images to obtain a plurality of second target areas; and obtaining an intersection area of the plurality of first target areas and the plurality of second target areas to obtain an area where the first object is located.

Based on the foregoing, the disclosure uses the object positioning device and method to analyze the pixel value variation and the brightness variation in continuous images, identify the intersection of the two, and determine the frequency of the flashing light source, which not only can eliminate the instability that may be caused by wind causing the object positioning device to shake during photography, but also can eliminate the noise generated when the target object is temporarily obscured by objects such as leaves, and determine the location of the target object. The object positioning device and method of the disclosure may be used for wilderness search and rescue in adverse weather conditions, as well as for ground-to-air lighting guidance to achieve precise positioning effects.

### BRIEF DESCRIPTION OF THE DRAWINGS

FIG. 1 is a schematic diagram of an object positioning device according to the disclosure.

FIG. 2 is a schematic diagram of an object positioning method according to the disclosure.

FIG. 3 is a flowchart of flashing light source detection.

FIG. 4 is a schematic diagram of the image processing results according to the disclosure.

FIG. 5 is a schematic diagram of peak detection according to the disclosure.

### DESCRIPTION OF THE EMBODIMENTS

Reference will now be made in detail to the present preferred embodiments of the disclosure, examples of which are illustrated in the accompanying drawings. The terms “first” and “second” and the like mentioned in the full text (including the scope of the patent application) of the description of this application are used only to name the elements or to distinguish different embodiments or scopes and are not intended to limit the upper or lower limit of the number of the elements, nor is it intended to limit the order of elements. Also, where possible, elements/components using the same reference numerals in the drawings and embodiments represent the same or similar parts.

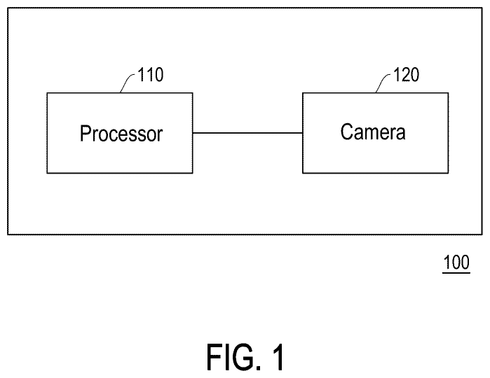

FIG. 1 is a schematic diagram of an object positioning device according to the disclosure. An object positioning device 100 may include a processor 110 and a camera 120.

In an embodiment of the disclosure, the processor is, for example, a central processing unit (CPU), or other programmable general-purpose or special-purpose micro control units (MCUs), microprocessors, digital signal processors (DSPs), programmable controllers, application-specific integrated circuits (ASICs), graphics processing units (GPUs), image signal processors (ISPs), image processing units (IPUs), arithmetic logic units (ALUs), complex programmable logic devices (CPLDs), field programmable gate arrays (FPGAs), or other similar devices, or a combination of the devices. In the object positioning device 100, the processor 110 may be coupled to the camera 120.

In an embodiment of the disclosure, the camera 120 may be an image capture device. All kinds of equipment that may record images through optical principles fall within the scope of the camera 120 of the disclosure.

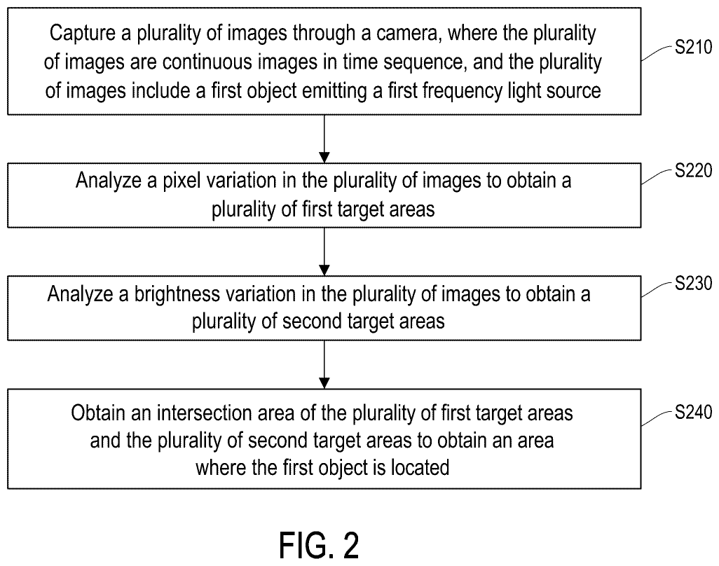

Referring to FIG. 2, FIG. 2 is a schematic diagram of an object positioning method according to the disclosure. In process S210, the processor 110 may capture a plurality of images through the camera, where the plurality of images are continuous images in time sequence, and the plurality of images include a first object emitting a first frequency light source. In process S220, the processor 110 may analyze a pixel variation in the plurality of images to obtain a plurality of first target areas. In process S230, the processor 110 may analyze a brightness variation in the plurality of images to obtain a plurality of second target areas. In process S240, the processor 110 may obtain an intersection area of the plurality of first target areas and the plurality of second target areas to obtain an area where the first object is located.

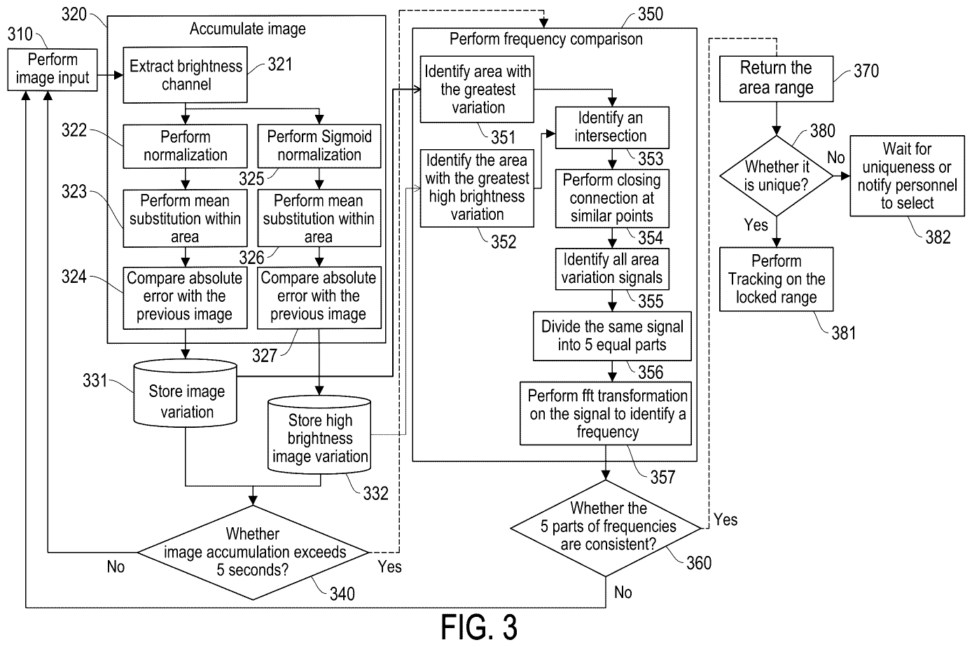

Referring to FIG. 3, FIG. 3 is a flowchart of flashing light source detection. Specifically, when the object positioning device 100 is performing object detection, the processor 110 may obtain images through the camera 120 and perform image input 310 to further analyze the captured images. It should be understood that when the object positioning device 100 is performing object detection, it may perform mobile image capture through a pre-configured ground detection path; or, after the processor 110 preliminarily determines the area range where the object is located, the object positioning device 100 may capture fixed point images. The processor 110 may mark the way in which a plurality of captured images are captured, in order to serve as the application of algorithms during subsequent image processing. The content of marking the capture method includes but is not limited to the moving speed, moving distance, and height above ground of the object positioning device 100. In this way, the processor 110 may identify the overlapping areas of a plurality of images according to the marked content of a plurality of images, and stitch them together to form the final image.

Continuing to refer to FIG. 3, the processor 110 may accumulate images 320 to confirm that the accumulated number of images is sufficient for the processor 110 to use for subsequent object recognition. Specifically, the disclosure determines the location of the target object by recognizing the fixed frequency signal or light source emitted by the target object. Therefore, it is necessary to analyze at least a certain amount of continuous images and compare the variation of fixed signals in continuous images to determine whether there is an object emitting a fixed frequency signal in the image. In an embodiment of the disclosure, the camera 120 may capture 30 frames of images per second, and the processor 110 may determine whether the image includes the target object based on analyzing 150 frames of images captured by the camera for at least 5 seconds.

In detail, when the processor 110 obtains each input image, the processor 110 may first extract a brightness channel 321, and the processor 110 may perform normalization 322 and Sigmoid normalization 325 on the image respectively. After the processor 110 normalizes the image, the processor 110 may continue to perform mean substitution within area 323, compare absolute error with the previous image 324, and store an image variation 331. Similarly, after the processor 110 performs Sigmoid normalization on the image, the processor 110 may continue to perform mean substitution within area 326, compare absolute error with the previous image 327, and store a high brightness image variation 332. The aforementioned normalization may be, for example, binarization.

Furthermore, the processor 110 may first obtain a first image and a second image among the continuous images, and obtain a plurality of first image pixels of the first image and a plurality of second image pixels of the second image, and the processor 110 may subtract the pixel points at corresponding positions of the first image and the second image to obtain a plurality of first pixel differences, thereby analyzing the areas where pixel differences are not 0 as target areas. In addition, in order to accumulate the image variation, the processor 110 may also obtain a third image among the continuous images and a plurality of third image pixels thereof, and subtract the pixels at corresponding positions of the plurality of third image pixels and the plurality of second image pixels to obtain a plurality of second pixel differences. The processor 110 may further obtain a plurality of target areas according to the plurality of first pixel differences and the plurality of second pixel differences. For example, the processor 110 may add the plurality of first pixel differences and the plurality of second pixel differences at corresponding positions, and set pixel positions that are not 0 as the plurality of target areas.

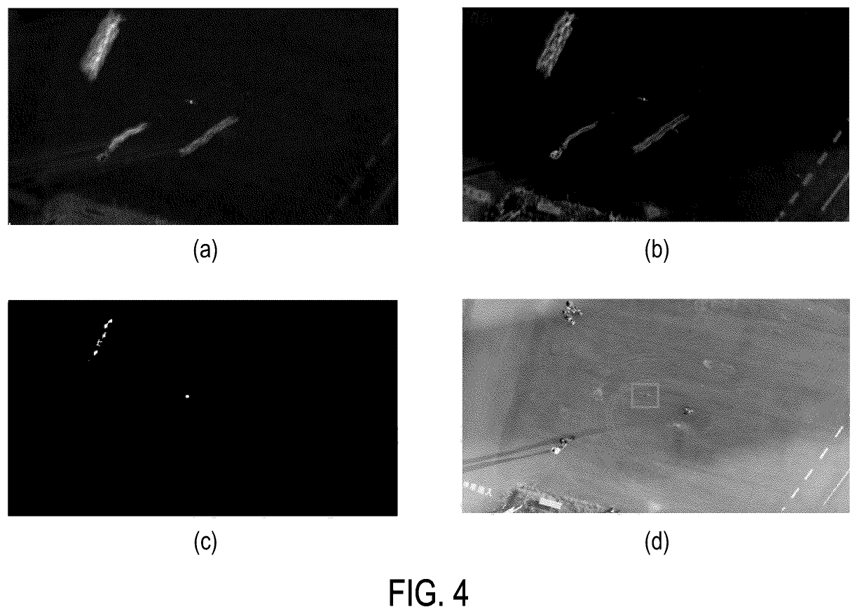

Referring to FIG. 3 and FIG. 4 at the same time, FIG. 4 is a schematic diagram of the image processing results according to the disclosure. More specifically, when the processor 110 performs image normalization 322, mean substitution within area 323, compares absolute error with the previous image 324, and stores an image variation 331, the result as shown in part (a) of FIG. 4 may be obtained. In part (a) of FIG. 4, the black area represents that the current image and the previous image have the same pixel values. Therefore, the processor 110 obtains 0 after comparing absolute error phase and subtracting the two images. In part (a) of FIG. 4, the white spots are pixel points that are not 0 after comparing absolute error between the continuous images. That is to say, when the camera 120 captures the continuous images, there may be slight errors in the captured images due to other external factors, such as wind interference. In addition, when the image contains flashing light spots, the images captured by the camera 120 during the alternation between bright and dark states of the light spots naturally contain different pixel values, and therefore after comparing absolute error between the continuous images, there will be values that are not 0.

Following the previous paragraph, when the processor 110 performs Sigmoid normalization 325, mean substitution within area 326, compares absolute error with the previous image 327, and stores a high brightness image variation 332, the result as shown in part (b) of FIG. 4 may be obtained. In part (b) of FIG. 4, the black area represents that the current image and the previous image have the same brightness values. Therefore, the processor 110 obtains 0 after comparing absolute error phase and subtracting the two images. In part (b) of FIG. 4, the white spots are brightness points that are not 0 after comparing absolute error between the continuous images. That is to say, when the camera 120 captures the continuous images, there may be different brightness at the same position due to other external factors, such as leaves blocking objects caused by wind interference. In addition, when the image contains flashing light spots, the images captured by the camera 120 during the alternation between bright and dark states of the light spots naturally contain different brightness values, and therefore after comparing absolute error between the continuous images, there will be values that are not 0.

Returning to FIG. 3, after the processor 110 analyzes the input image to obtain the image variation and the high brightness image variation, the processor 110 may determine whether the image accumulation exceeds 5 seconds 340. In an embodiment of the disclosure, since the camera 120 may capture 30 frames of images per second, the processor 110 may determine whether the accumulated images exceed 150 frames (5 multiplied by 30) as a determination of whether the accumulated images are sufficient. If the processor 110 determines that the accumulated images have not reached 150 frames, the processor 110 returns to the image input 310 process and continues to input and analyze the captured images. If the processor 110 determines that the accumulated images have reached 150 frames, the processor 110 enters the frequency comparison 350 phase.

Following the previous paragraph, since the accumulated images exceed 150 frames, the processor 110 may first identify the area 351, which exhibits the greatest variation, from the plurality of images of stored image variation. Specifically, since the disclosure aims to identify the target object by detecting light spots emitting a stable frequency, and the light spots emitting a stable frequency may exhibit a stable variation in the pixel values, by identifying the area with the greatest variation, the area where the target object is located may be extracted. Similarly, since the light spots emitting a stable frequency may also exhibit a stable variation in the high brightness variation, by identifying the area with the greatest high brightness variation, the area where the target object is located may be extracted. Therefore, the processor 110 may identify the area with the greatest high brightness variation 352 from the plurality of images of stored high brightness image variation. The definition of the greatest variation mentioned above can be, for example, determining the area with the most frames of non-zero pixels among the more than 150 frames of images, or determining the area where more than eighty percent of images present non-zero pixels in a plurality of variation images. The implementer of the disclosure may adjust the threshold of the number of images presenting variation according to the actual application as the selected area.

Continuing to refer to FIG. 3, after the processor 110 identifies a plurality of first areas with the greatest variation and a plurality of second areas with the greatest high brightness variation, the processor 110 may identify an intersection 353 of the plurality of first areas and the plurality of second areas, and the processor 110 may also make closing connection 354 at similar points. Then the processor 110 may identify all area variation signals 355, divide the same signal into 5 equal parts 356, and perform fft transformation on the signal to identify a frequency 357.

In FIG. 3, in the frequency comparison phase, specifically, since the accumulated images exceed 150 frames, after the processor 110 identifies the intersection of areas and divides the images into 5 equal parts, each part has at least 1 second of accumulated variation images (at least 30 frames). If the target object is included in the image, then in each part of the accumulated variation images, there exists at least a signal with the frequency emitted by the target object. The processor 110 may compare whether the 5 parts of frequencies are consistent? 360 to determine whether the target object exists in the area with the greatest variation. If the frequencies of the 5 parts are consistent, the processor 110 may return that area range 370, and the processor 110 may also determine whether this area is unique? 380. If it is, the processor 110 may perform Tracking on the locked range 381, and the processor 110 may lower the height of the object positioning device 100 to capture surround-view images of the locked range and more accurately detect to identify the exact positioning of the target object. If the frequencies of the 5 parts are not consistent, then processor 110 returns to the image input 310 process, and continues to conduct comparison detection of the next batch of images.

Following the previous paragraph, if the area range is not unique, the processor 110 may wait for uniqueness or notify personnel to select 382. That is, the processor 110 may continuously collect images and analyze the collected images to obtain more frequency information and narrow down the intersection area to identify the unique area where the target object is located. Or the processor 110 may emit a signal to notify relevant personnel to select the area where the target object is located.

Referring to part (c) of FIG. 4, part (c) of FIG. 4 is the intersection area found through the area with the maximum variation in part (a) of FIG. 4 and the area with the maximum brightness variation in part (b) of FIG. 4. The processor 110 may further obtain the exact position of the target object as shown by the red point in the green box in part (d) of FIG. 4 through the aforementioned comparison of whether the 5 parts of frequencies are consistent.

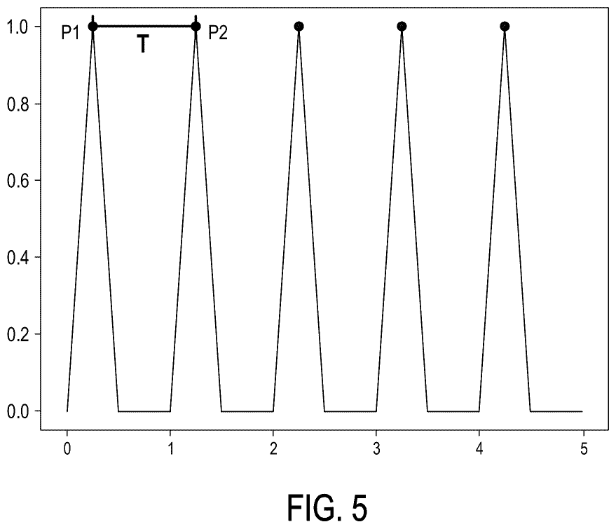

The detailed content of dividing the accumulated variation images into five parts and conducting frequency comparison may be as shown in FIG. 5. Referring to FIG. 5, FIG. 5 is a schematic diagram of peak detection according to the disclosure, with the horizontal axis representing time in seconds(s) and the vertical axis representing amplitude. The disclosure aims to identify the location of the flashing light source emitted by the target object. The signal emitted by the flashing light source usually appears as a triangular wave, and this waveform characteristic typically has obvious rising and falling edges. Therefore, through detecting the triangular wave, the target object may be found more quickly. Specifically, the processor 110 may use the camera 120 to take a plurality of images during the first second for peak detection, thereby determining the period of the signal and calculating the base frequency. Specifically, the processor 110 may obtain the base frequency based on the pixel variation or brightness variation of the plurality of first-second images. This base frequency will serve as the reference for subsequent signal analysis, and is also the basis for determining the area where the target object is located. For the frequency analysis of triangular waves, the processor 110 may determine the period by detecting the peaks of the waveform. The peaks are the local highest points of the waveform, and represent the vertices of the waveform, as shown by peak P1 and peak P2 in FIG. 5. The processor 110 then determines a period T according to peak P1 and peak P2, and may further determine the frequency of the flashing light source according to the period T.

In an embodiment of the disclosure, since the object positioning device 100 may capture images while moving, the processor 110 needs to apply a Sliding Window to the corresponding calculated pixel points when analyzing continuous images, so that the positions of the pixel points calculated in continuous images are the same position and match the actual position. In addition, since the processor 110 needs to capture images for 5 seconds when calculating the base frequency, and the movement of the object positioning device 100 may result in fewer overlapping pixel positions in the captured images, when analyzing continuous images of the moving object positioning device 100, the processor 110 may preset to obtain an extra 1 second, that is, a total of 6 seconds of continuous images to be used for subsequent base frequency analysis. In other embodiments of the disclosure, the processor 110 may preset to obtain images for additional seconds for subsequent base frequency analysis.

The disclosure also provides an object positioning method, which may be implemented by the processor 110 of the object positioning device 100. The detailed process of the object positioning method is all presented in the preceding paragraphs, and will not be repeated here.

In summary, the disclosure uses the object positioning device and method to analyze the pixel value variation and brightness variation in continuous images, identify the intersection of the two, and determine the frequency of the flashing light source, which not only can eliminate the instability that may be caused by wind causing the object positioning device to shake during photography, but also can eliminate the noise generated when the target object is temporarily obscured by objects such as leaves, and determine the location of the target object. The object positioning device and method of the disclosure may be used for wilderness search and rescue in adverse weather conditions, as well as for ground-to-air lighting guidance to achieve precise positioning effects.

What is claimed is:

1. An object positioning device, comprising:
a camera; and
a processor, coupled to the camera, and configured to:
capture a plurality of images through the camera, wherein the images are continuous images in time sequence, and the images comprise a first object emitting a first frequency light source;
analyze a pixel variation in the images to obtain a plurality of first target areas;
analyze a brightness variation in the images to obtain a plurality of second target areas; and
obtain an intersection area of the first target areas and the second target areas to obtain an area where the first object is located.

2. The object positioning device according to claim 1, wherein the processor is further configured to:
perform binarization on the images to obtain the first target areas.

3. The object positioning device according to claim 1, wherein the processor is further configured to:
obtain a plurality of first image pixels of a first image among the images and a plurality of second image pixels of a second image among the images;
subtract a plurality of pixel values at corresponding positions of the first image pixels and the second image pixels to obtain a plurality of first pixel differences; and
analyze the first pixel differences to obtain the first target areas.

4. The object positioning device according to claim 3, wherein the processor is further configured to:
obtain a plurality of third image pixels of a third image among the images;
subtract a plurality of pixel values at corresponding positions of the second image pixels and the third image pixels to obtain a plurality of second pixel differences; and
analyze the first pixel differences and the second pixel differences to obtain the first target areas.

5. The object positioning device according to claim 4, wherein the processor is further configured to:
add the first pixel differences and the second pixel differences at corresponding positions, and set pixel positions that are not 0 as the first target areas.

6. The object positioning device according to claim 3, wherein the processor is further configured to:
obtain a plurality of pixel points that are not 0 among the first pixel differences as the first target areas.

7. The object positioning device according to claim 1, wherein the processor is further configured to:
obtain a plurality of first time images captured during a first time interval from the images;
obtain a base frequency according to the pixel variation or the brightness variation of the first time images; and
determine the area where the first object is located according to the base frequency and the images.

8. The object positioning device according to claim 7, wherein the processor is further configured to:
obtain a peak value of the base frequency according to the first time images; and
obtain a period of the base frequency from the images according to the peak value.

9. The object positioning device according to claim 1, wherein the processor is further configured to:
obtain a plurality of fixed point images through the camera by capturing fixed point images of the intersection area; and
obtain a precise positioning of the first object according to the fixed point images.

10. The object positioning device according to claim 1, wherein the processor is further configured to:
obtain a plurality of surround-view images through the camera by capturing surround-view images of the intersection area; and
obtain a precise positioning of the first object according to the surround-view images.

11. A method of object positioning, comprising:
capturing a plurality of images through a camera, wherein the images are a plurality of continuous images in time sequence, and the images comprise a first object emitting a first frequency light source;
analyzing a pixel variation in the images to obtain a plurality of first target areas;
analyzing a brightness variation in the images to obtain a plurality of second target areas; and
obtaining an intersection area of the first target areas and the second target areas to obtain an area where the first object is located.

12. The object positioning method according to claim 11, further comprising:
performing binarization on the images to obtain the first target areas.

13. The object positioning method according to claim 11, further comprising:
obtaining a plurality of first image pixels of a first image among the images and a plurality of second image pixels of a second image among the images;
subtracting a plurality of pixel values at corresponding positions of the first image pixels and the second image pixels to obtain a plurality of first pixel differences; and
analyzing the first pixel differences to obtain the first target areas.

14. The object positioning method according to claim 13, further comprising:
obtaining a plurality of third image pixels of a third image among the images;
subtracting a plurality of pixel values at corresponding positions of the second image pixels and the third image pixels to obtain a plurality of second pixel differences; and
analyzing the first pixel differences and the second pixel differences to obtain the first target areas.

15. The object positioning method according to claim 14, further comprising:
adding the first pixel differences and the second pixel differences at corresponding positions, and setting pixel positions that are not 0 as the first target areas.

16. The object positioning method according to claim 13, further comprising:
obtaining a plurality of pixel points that are not 0 among the first pixel differences as the first target areas.

17. The object positioning method according to claim 11, further comprising:
obtaining a plurality of first time images captured during a first time interval from the images;
obtaining a base frequency according to the pixel variation or the brightness variation of the first time images; and
determining the area where the first object is located according to the base frequency and the images.

18. The object positioning method according to claim 17, further comprising:
obtaining a peak value of the base frequency according to the first time images; and
obtaining a period of the base frequency from the images according to the peak value.

19. The object positioning method according to claim 11, further comprising:
obtaining a plurality of fixed point images through the camera by capturing fixed point images of the intersection area; and
obtaining a precise positioning of the first object according to the fixed point images.

20. The object positioning method according to claim 11, further comprising:
obtaining a plurality of surround-view images through the camera by capturing surround-view images of the intersection area; and
obtaining a precise positioning of the first object according to the surround-view images.
